(19) United States
(12) Patent Application Publication
(10) Pub. No.: US 2018/0009532 A1
(43) Pub. Date: Jan. 11, 2018

(54) AIRCRAFT COCKPIT MODULE, AIRCRAFT COMPRISING SUCH A MODULE AND METHOD FOR INSTALLING THE MODULE IN A COCKPIT

(71) Applicant: AIRBUS OPERATIONS (SAS), Toulouse (FR)

(72) Inventors: Olivier CAZALS, Blagnac (FR); Jaime GENTY DE LA SAGNE, Toulouse (FR)

(21) Appl. No.: 15/643,793

(22) Filed: Jul. 7, 2017

(30) Foreign Application Priority Data
Jul. 8, 2016 (FR) 1656570

(51) Int. Cl. B64D 11/06; B64D 43/00

(52) U.S. Cl. CPC B64D 11/0602; B64D 11/0689; B64D 43/00

(57) ABSTRACT

An aircraft cockpit module (10) that incorporates, on the one hand, a single pilot seat (12) and, on the other hand, at least a part of the piloting equipment and controls necessary for flying an aircraft, the module (10). The aircraft cockpit module forms an assembly which can be moved unitarily and to be incorporated in a single operation in an aircraft cockpit. The module is dedicated to a single pilot and makes it possible to simplify the integration of the cockpit.

### TECHNICAL FIELD

The Invention relates to an aircraft cockpit module, an aircraft including such a module and a method for installing such a module in an aircraft cockpit.

### PRIOR ART

A conventional aircraft cockpit (apart from a fighter airplane) comprises various equipment and controls which are necessary for flying the aircraft. One equipment item is for example an embedded computer, computing hardware, a screen but also an instrument such as a measuring instrument. A control is a piloting control such as the rudder bar, the joystick, etc.

Such equipment and controls are distributed around the cockpit in the form:
of a main navigation instrument panel (main instrument panel) which extends transversely in the manner of a dashboard in front of the seats of the pilot and of the co-pilot and as far as the sides, such a panel comprising in particular displays of PFD, ND type, and the like;
a panel (Glareshield) arranged above the main instrument panel, between the latter and the windshield and which is an automatic pilot setting strip;
a central console (pedestal) arranged between the seats of the pilot and of the co-pilot and on which are arranged in particular the throttle controls, the control surface and flap controls, the on board computers and the radios for communicating with air traffic controllers, etc.;
an overhead panel which is arranged on the ceiling of the cockpit and above the central console, this panel comprising in particular knobs and switches making it possible to control different systems of the aircraft (lights and beacons, de-icing, pressurization, air-conditioning, electricity, fuel, hydraulics, extinguishers in the jet engines, etc.);
two sets of pedals (rudder bar) situated under the main navigation instrument panel each in front of the seat of the pilot and of the co-pilot.

These equipment items and controls are each embedded in a particular zone of the structure accommodating the cockpit and are fixed therein in a way specific to each equipment item.

During the cockpit integration phase, the various equipment items and controls must be brought into the cockpit, positioned in the location provided in the accommodating structure of the cockpit. The equipment items and controls must be assembled mechanically and electrically with the mechanical and electrical interfaces provided on the accommodating structure of the cockpit.

This integration phase is particularly lengthy and complicated.

It would consequently be advantageous to be able to simplify this integration phase.

### SUMMARY OF THE INVENTION

Thus, the subject of the invention, according to a first aspect, is an aircraft cockpit module, characterized in that the module incorporates a single pilot seat and at least a part of the piloting equipment and controls necessary to fly an aircraft, the module comprising structural elements which, when assembled with the seat, form said module, said at least a part of the piloting equipment and controls being divided up between the seat and at least some of the structural elements, the module forming an assembly which is configured to be moved unitarily and to be integrated in a single operation in an aircraft cockpit.

At least a part of the piloting equipment and controls necessary for flying an aircraft are now grouped together in a removable cockpit module, independent of the accommodating structure of the cockpit and which notably incorporates a pilot seat (part of the piloting equipment and controls is not only present on the seat). Said at least a part of the piloting equipment and controls is no longer located in separate equipment items that have to be brought and assembled one by one to the accommodating structure of the cockpit. Thus, the cockpit integration phase is greatly simplified.

According to other possible features:
the module is designed in such a way that all the structural elements assembled mechanically with the seat has a mechanical rigidity enabling said module to be transported in a single block and installed in an aircraft cockpit in a final functional position;
the structural elements of the module comprise a part forming a support of the seat and to which the seat is fixed;
the structural elements of the module form a structure which at least partially surrounds the seat and which forms a mechanical framework to which the seat is fixed;
the structure supports at least some of the piloting equipment and/or controls;
the structure at least partially surrounds the seat according to a view taken at right angles to a plane containing, on the one hand, a longitudinal axis x corresponding to the axis of alignment from the front to the rear of the seat and, on the other hand, a vertical axis z corresponding to the height of the seat and at right angles to the longitudinal axis;
the structure has a generally S or G shape according to the view taken at right angles to the plane x, z;
the seat comprises at least some piloting controls;
the module comprises a structure to which the seat is fixed;
the structure comprises a front part arranged in front of the seat and which incorporates piloting equipment and/or controls;
the front part arranged in front of the seat comprises a rudder bar system;
the structure comprises a support-forming part on which the seat rests and to which the front part is linked;
the structure comprises an upper part arranged above the seat and which incorporates piloting equipment and/or controls;
the upper part extends behind the seat so as to meet the support-forming part;
the module comprises all the piloting equipment and controls necessary for flying an aircraft;
the seat includes two armrests, one of which houses flight controls;
the other armrest houses throttle controls;
at last one of the two armrests is articulated to be able to be retracted in a position which leaves lateral access to the seat free;
the module has a width or transverse dimension which is adapted to the width of an opening for access to an aircraft cockpit;
the module comprises mechanical link elements and electrical connection elements which are intended respectively to cooperate mechanically and electrically with an aircraft cockpit;

Also a subject of the invention, according to a second aspect, is an aircraft, characterized in that it comprises a cockpit and at least one aircraft cockpit module as briefly set out above, said at least one module being fixed to the interior of the cockpit. Said at least one module is distinct from (independent of) the cockpit in as much as it does not constitute the cockpit itself but forms a unitary assembly which is incorporated in the structure of the cockpit (cockpit internal volume which defines an accommodating structure for locating the module or modules).

According to other possible features:
the module is configured to be transported inside the cockpit and to be located and fixed in a final functional position in the cockpit;
said at least one module has a width or transverse dimension which is adapted to the width of an opening for access to the cockpit of the aircraft;
said at least one aircraft cockpit module is fixed to a floor of the cockpit;
the Interfacing between said at least one aircraft cockpit module and the cockpit is limited to the floor of the cockpit.

Also a subject of the invention, according to a third aspect, is a method for installing an aircraft cockpit module in an aircraft or for removing an aircraft cockpit module from the aircraft, characterized in that the aircraft comprises an opening for access on board the aircraft and/or an opening for access to an aircraft cockpit, the method comprising a step of passing the module as briefly set out above through said access opening. The access opening can be an opening for access on board to introduce the module on board the aircraft or remove it therefrom. The access opening can be an opening for access to the cockpit to introduce the module into the cockpit or to remove it therefrom.

### BRIEF DESCRIPTION OF THE FIGURES

Other features and advantages will become apparent from the following description, given purely as a nonlimiting example and with reference to the attached drawings, in which:

FIG. 1 illustrates a rear perspective schematic view of an aircraft cockpit module according to an embodiment of the invention;

FIGS. 2 and 3 are perspective schematic views showing the passing of an aircraft cockpit module according to an embodiment of the invention through different openings of an aircraft;

FIG. 4 is a schematic view in longitudinal cross section of a nose cone of an aircraft showing an aircraft cockpit module according to an embodiment of the invention located in a cockpit;

FIG. 5 is an enlarged perspective schematic view from above of the cockpit module of FIG. 4 in the absence of the aircraft fuselage;

FIG. 6 is a plan schematic view of a possible location in an aircraft cockpit of two aircraft cockpit modules according to an embodiment of the invention;

FIG. 7 is a plan schematic view of another possible location in an aircraft cockpit of two aircraft cockpit modules according to an embodiment of the invention;

FIG. 8 is a view from above of FIG. 7.

### DETAILED DESCRIPTION

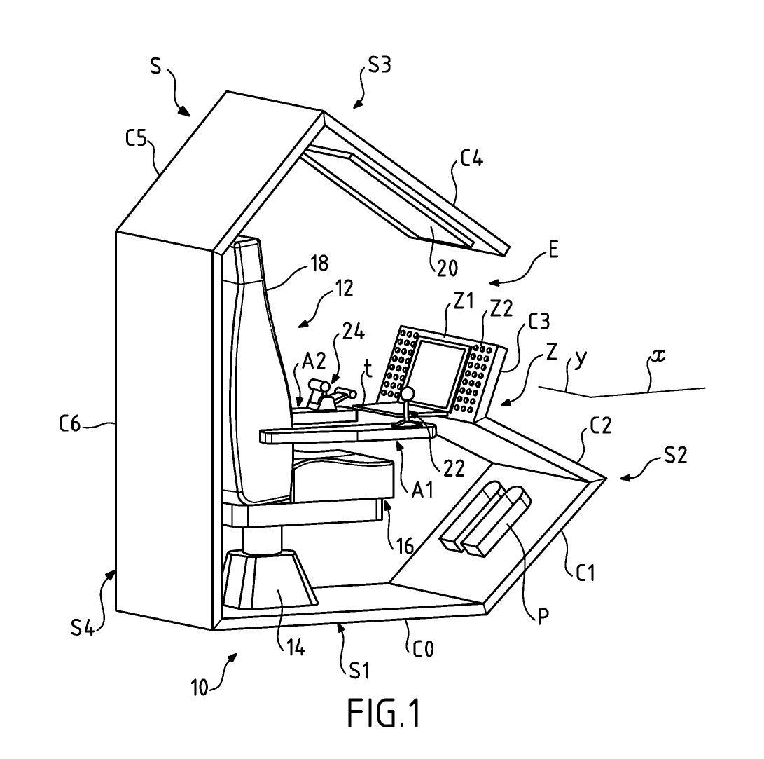

An aircraft cockpit module according to an embodiment of the invention is represented in FIG. 1. The module 10 forms an assembly or physical entity independent of the cockpit which is configured to be moved unitarily (in a single piece) and to be incorporated in a single operation in an aircraft cockpit. To do this, the module is designed in such a way that its components or structural elements are assembled mechanically together in a sufficiently rigid manner for all of these duly assembled components (forming the module) to have a strength or mechanical rigidity enabling it to be transported in a single block (structural module). The transportation is for example performed from a location outside of an aircraft to a place of functional locating of the module inside the aircraft cockpit and vice versa.

The module 10 is dedicated to a single pilot. This module incorporates a single pilot seat 12 and at least a part of the piloting equipment and controls which are necessary for flying an aircraft.

Equipment will be understood generally, for example, to mean an embedded computer, computing hardware, a screen, but also an instrument such as a measuring instrument, etc.

Piloting control will be understood generally to mean one or more members whose actuation by a pilot makes it possible to execute piloting, navigation and other such functions (e.g.: rudder bar, joystick, etc.).

The seat comprises at least some of the above-mentioned piloting controls. It will be noted that said at least a part of the piloting equipment and controls of the module is not necessarily present on the seat. In effect, the module does not comprise only a pilot seat fully equipped with all such equipment and/or controls as in the prior art but it comprises other structural elements (or components) which, when assembled mechanically with the seat, jointly form the module. These other structural elements form or accommodate piloting equipment and/or controls which complement the equipment and/or controls of the seat. Such piloting equipment and controls are notably those taken in a conventional cockpit (conventional central console, main navigation instrument panel already mentioned above (main instrument panel) and other components of the cockpit, the main navigation instrument panel notably comprising displays of PFD, ND type, and the like).

In the example described, the module 10 comprises all of the piloting equipment and controls necessary for flying an aircraft.

The module 10 has a width or transverse dimensions (according to an axis y in FIG. 1) which is generally dictated by the width of the seat. The module extends longitudinally according to an axis x along which the front and the rear of the seat are aligned (FIG. 1). The axes x and y are axes of a geometrical reference frame linked to the module 10. The longitudinal axis x of the module is intended to be arranged parallel to the longitudinal axis x of the aircraft when the module is located in an aircraft cockpit (FIG. 3) in order for the pilot installed in the module to be placed facing the windshield of the cockpit.

The module 10 comprises, for example, an S structure at least partially surrounding the seat 12 and which is formed by structural elements. The S structure here forms a chassis or mechanical framework to which the seat 12 is for example fixed. This rigid S structure comprises, for example, several parts including a part S1 forming a support of the seat 12. The seat 12 is fixed to the support S1 by a base plate or base 14 arranged under the bottom rest 16 of the seat and for example secured thereto. The part S1, for example horizontal, is intended to be arranged on a cockpit floor and to be fixed thereto as will be seen hereinbelow.

The S structure can also comprise a front part S2 linked mechanically to the support part S1 in a conventional manner, for example by screwing/bolting. The front part S2 is arranged in front of the seat 12 (in the alignment of the axis x) and can incorporate piloting equipment and controls.

More particularly, the front part S2 can include a rudder bar system represented here by two mechanical or electrical rudder bars jointly referenced P. The front part S2 can also include, above the rudder bar system, a support Z for an Information display zone, formed for example by several screens or just one z1. The support Z can also include a plurality of equipment items z2 represented in the form of knobs or control members. A foldaway tablet t can also form part of the support Z.

The structure S can also include an upper part S3 arranged above the seat 12. The upper part S3 notably incorporates equipment such as knobs or other control members and screen(s) which for example form part of a panel 20.

The upper part S3 extends above the seat and meets a rear part S4. The rear part S4 extends substantially vertically behind the backrest 18 of the seat and running along the latter, so as to meet the support-forming part S1.

The structure S has for example a generally C or G shape according to a lateral view (view taken according to the axis y). The structure can in fact comprise, generally (independently of the modes illustrated in the figures), a seat support-forming part S1 and two other parts S2 and S3 each forming a return, respectively under the seat (lower return for the part S2) and above the seat (upper return for the part S3). Each return partially encloses the module, either by the front lower part, by the lower return S2, or by the front upper zone, by the upper return S3. Generally (Independently of the modes illustrated in the figures), the structure S partially (or totally) surrounds the seat according to a line contained in a plane which contains, on the one hand, the axis x of alignment from the front to the rear of the seat and, on the other hand, the vertical axis z corresponding to the height according to which the seat extends (view taken laterally according to the axis y). The structure can be laterally open.

In the example illustrated in the figures, the respective free ends of the lower S2 and upper S3 parts do not meet in order to leave between them a space E free. This clear space or frontal opening E faces the upper part of the seat 12 intended to be occupied by a pilot. Thus, the pilot can see outside of the module through the central opening E. Here, the structure partially surrounds the seat.

In this example, the module is open on the two opposite sides or lateral flanks in order to allow a lateral access to the module (access according to the axis y at right angles to the longitudinal axis x of the module): entry of the pilot into the module (and his or her installation in the seat) and exit from the module through one of the two lateral openings.

The structure S can be formed by box sections or panels assembled conventionally together two by two, for example, by two respective adjacent edges, for example by screwing/bolting. These box sections are generally in order to house therein equipment items and different types of system circuits such as electrical, aeraulic, pneumatic, hydraulic circuits necessary for supplying electricity and fluid(s) to the various piloting equipment items and controls of the module.

More particularly, in the example of the figures, the support part S1 comprises a horizontal box section C0.

The front part S2 includes, for example, three box sections C1 to C3 assembled two by two by their respective adjacent edges. The first two box sections C1 and C2 are in the form of a dihedron or of a point whose interior faces the seat 12. The third box section C3 extends substantially vertically from the adjacent edge of the second box section C2 moving away from the box section C0. The third box section C3 is arranged opposite the backrest 18 so as to be able to be used as a screen or instrument panel for the pilot seated in the seat 12. The third box section C3 Incorporates the abovementioned elements z1, z2 and t of the support Z. The rudder bar system P is, for its part, incorporated in the first box section C1. The assembly of the box sections C1-C3 (front part S2) forms the lower return of the module which partially encloses the module by the front lower zone.

The upper part S3 comprises two box sections C4 and C5 assembled by their two respective adjacent edges so as to jointly confer on this assembly the general form of a roof with two slopes. This assembly forms the upper return of the module which partially encloses the module by the front upper zone. The panel 20 (overhead panel) is incorporated in the box section C4 which is oriented/inclined towards the seat 12 in order to be visible and reachable by the pilot installed in the seat. The panels C3 and C4 separated from one another delimit between them the central opening E.

The rear part S4 here comprises a single vertical box section C6 linked at its two top and bottom opposite edges respectively to the box section C5 and to the box section C0.

The seat 12 comprises two armrests A1 and A2. The armrest A1 houses, for example, the flight controls 22.

The other armrest A2 houses the throttle controls 24 which make it possible to adjust the power applied to each of the engines (these controls include the members and/or the levers and/or knobs making it possible to start the engines).

At least one of the two armrests is articulated to be able to be retracted, for example raised, in a position which frees lateral excess to the seat. The armrest concerned is for example articulated at its end linked to the backrest of the seat. It can then be lowered into a horizontal position, as in FIG. 1, when the pilot is seated in the seat (seat located in the cockpit) or else when no pilot is seated in the seat or even when the module is outside of the aircraft (for example for the transportation of the module).

In the example described, the two armrests A1 and A2 are mounted in an articulated manner in order to access the seat through the two opposite sides of said seat.

Moreover, the module 10 has a width or transverse dimension (taken according to the axis y) which can be adapted to the width of an opening/door for access on board the aircraft and/or to the width of an opening/door for access to the cockpit of the aircraft for the passage of the module through the opening.

This dimensioning enables the module to be put in place inside an aircraft and to be removed therefrom, if necessary, for example for maintenance requirements.

The height of the module is also adapted to allow the passage of the module through the abovementioned opening or openings.

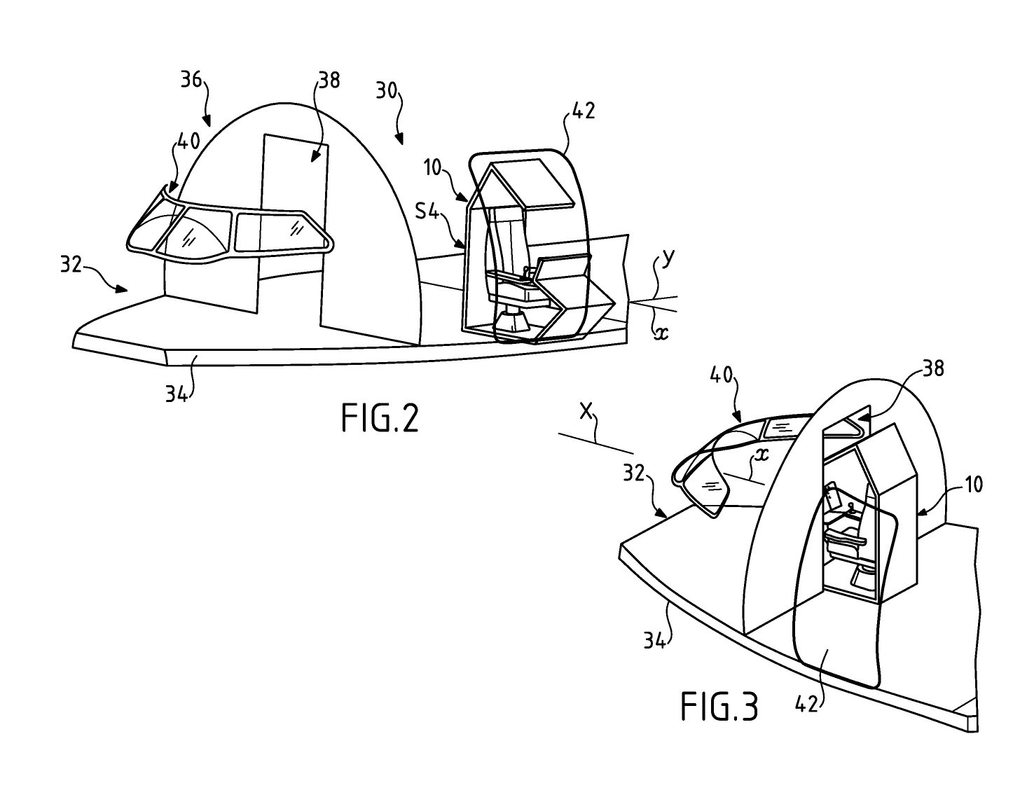

FIG. 2 is a very schematic perspective view of the Interior of an aircraft 30, taken from the front thereof. For clarity, only a few elements of the interior of a part of the nose cone of the aircraft have been represented, namely:
a part of the cockpit 32,
a cockpit floor 34,
a bulkhead 36 separating the rear of the cockpit 32 from the rest of the aircraft (cabin space), the bulkhead 36 being provided with an opening 38 for access to the cockpit and for exiting from the cockpit (this opening is normally closed by an access door which has been omitted for clarity),
a windshield 40 situated in a part of the nose cone,
an opening 42 for access on board the aircraft (only the outline of this opening has been represented and the door which closes this opening has been omitted for clarity).

FIG. 2 illustrates the passage of the module 10 through the opening 42 for its introduction on board the aircraft (the opening 42 is used for example also for the embarkation of flight personnel and certain passengers). The module is represented for example by its rear face (rear part S4) which faces the opening 42. The width of the module (according to the axis y) is positioned facing the opening and the longitudinal axis x of the module is at right angles to the section of passage of said opening. Alternatively, the module can be offered up by its front face facing the opening 42.

The handling of the module for passing it through the opening 42 can be done manually or using a conventional rig.

FIG. 3 illustrates the same simplified aircraft interior as in FIG. 2 but according to a perspective view taken from the rear and from above.

FIG. 3 illustrates the passage of the module 10 through the opening 38 for its introduction and installation in the cockpit 32.

The module 10 can have been introduced on board the aircraft through the opening 42 (for example as explained with reference to FIG. 2) or through the rear of the aircraft in the case where the rear is still open at this stage of the aircraft integration phase.

The same comments as for the passage through the opening 42 apply also to the passage through the opening 38, except that the module 10 is offered up here by its front face (front part S2) situated opposite the opening 38. This orientation of the module makes it possible to directly position the latter in the cockpit in its final functional position without need to turn it by 180°. The longitudinal axis x of the module is aligned with the longitudinal axis X of the aircraft.

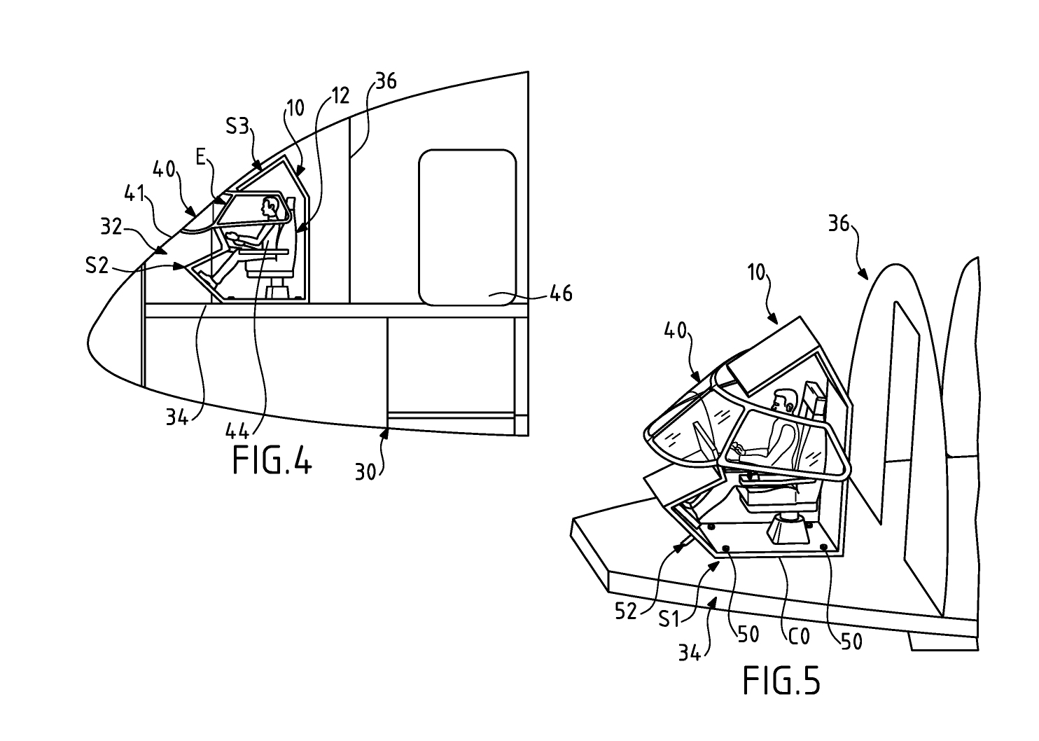

FIG. 4 illustrates the module 10 in position installed in the aircraft cockpit with a pilot 44 seated in the seat 12 (the fuselage of the nose cone of the aircraft has here been represented).

The module 10 is arranged above the cockpit floor 32 and is fixed mechanically thereto in a conventional manner.

As represented, the front opening E of the module is situated opposite the windshield 40 and has substantially the same dimensions heightwise as the windshield. It will be noted that the free end of the upper part S3 is not directly above the free end of the lower part S2 but set back. This arrangement makes it possible to adapt to the profile of the upper internal wall 41 of the cockpit 32 (wall in which the windshield is mounted). This profile is curved downward towards the front end of the aircraft. The front opening E seen in profile (FIG. 4) substantially follows the profile of the internal wall 41. The front part S2 of the module forms an advance relative to the rest of the module, which allows the latter to be positioned as far as possible towards the front and the bottom of the cockpit, where the free space is tight.

A door 46, for example of type A, closes the opening 42 of FIG. 2.

FIG. 5 is a perspective view from above and to one side of the cockpit module 10 of FIG. 3 in position installed in the cockpit 32. The module is arranged in the position of FIG. 4.

The module 10 comprises mechanical link elements 50 which are intended to mechanically assemble the lower part S1 of the module with an aircraft cockpit.

More particularly, the mechanical link elements 50 are joining elements with an accommodating structure of the cockpit (here, the cockpit floor 34) such as conventional screw/bolt-type elements. As represented in FIG. 5, four elements 50 are positioned at the four corners of the panel C0. Alternatively, a different number of mechanical link elements can be envisaged, as can a different type of mechanical link element.

The module also comprises electrical connection elements 52 which are intended to cooperate electrically with the electrical system or systems of an aircraft cockpit, in particular with an accommodating structure of the cockpit (here the cockpit floor 34).

These elements 52 ensure the electrical connections necessary for powering the various piloting items and controls of the module and for receiving this information/electrical signals from the various systems and equipment items external to the module (situated in the cockpit and/or elsewhere) such as sensors, computers, etc. These elements 52 also make it possible to transmit, to the various systems and equipment items external to the module (situated in the cockpit and/or elsewhere), the information/electrical signals necessary to the operation of the aircraft and in particular to the control of the various external systems and equipment items (engines, flaps, control surfaces, etc.).

The elements 52 can also comprise the connections to the air conditioning system(s) of the aircraft. In this respect, the module comprises an internal ventilation system or circuit connected, via the air-conditioning interface 52, to the air conditioning system of the nose cone of the aircraft.

Thus, the only interfaces (mechanical, electrical and aeraulic, when the latter are present) between the module and the cockpit are made with the floor of the cockpit.

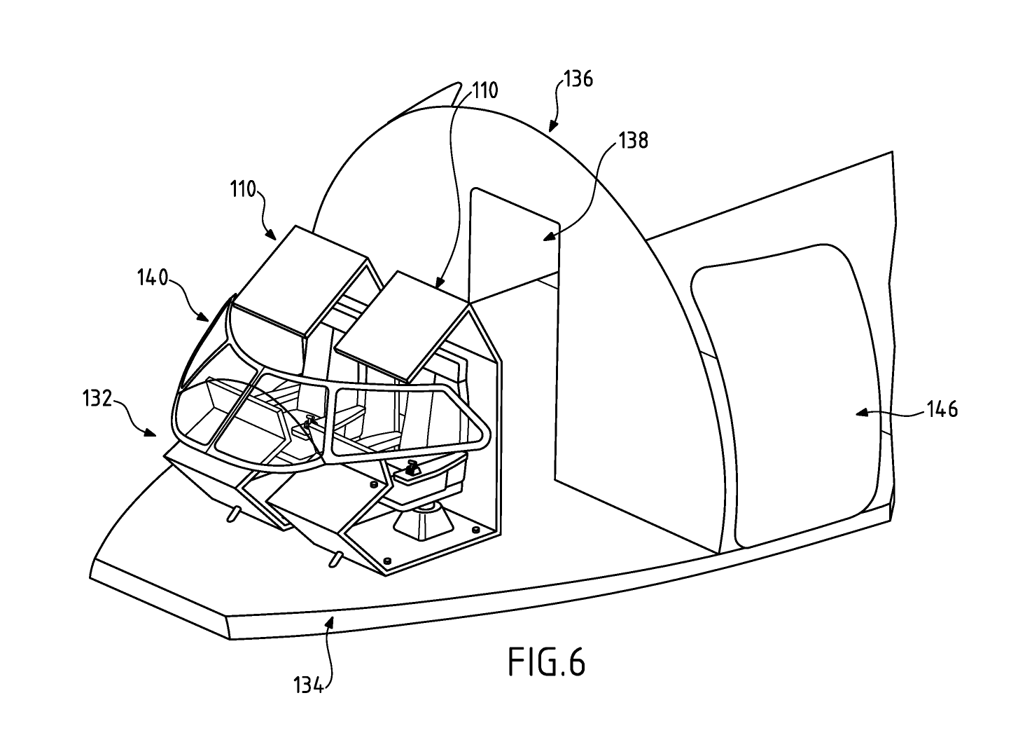

FIG. 6 illustrates a possible module installation configuration in an aircraft cockpit according to another embodiment of the invention. FIG. 6 is a perspective view from the front, from above and to one side of an aircraft cockpit 132 in which only the cockpit floor 134, the bulkhead 136 and its opening 138, the windshield 140 and the door 146 have been represented for clarity. These various elements are identical to the corresponding elements described with reference to the preceding figures.

In this figure, two modules 110, for example identical to the module 10 described above, have been represented installed side-by-side, parallel to one another. This configuration is provided for two pilots (a pilot and a co-pilot).

The installation of the modules is identical to what was described with reference to FIG. 5.

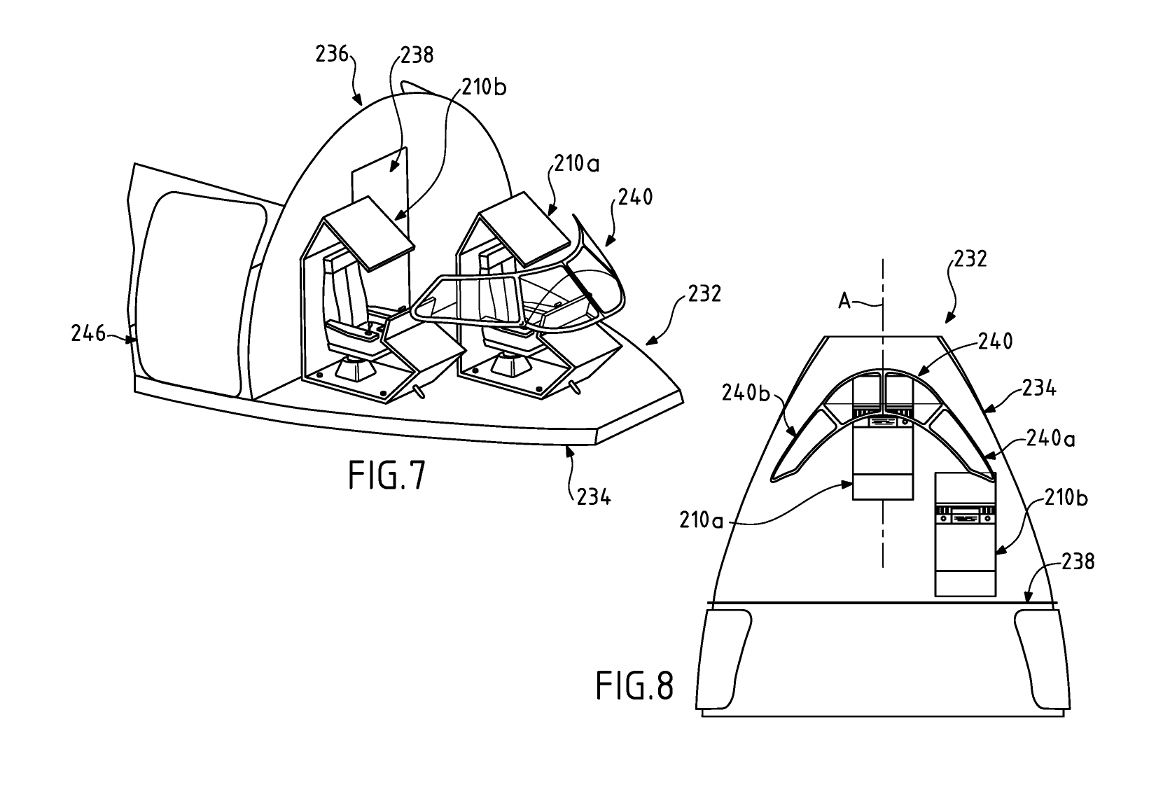

FIGS. 7 and 8 illustrate a possible module installation configuration in an aircraft cockpit according to yet another embodiment of the invention. FIG. 7 is a perspective view from the front, from above and to one side (side opposite to that of FIG. 6) of an aircraft cockpit 232 in which only the cockpit floor 234, the bulkhead 236 and its opening 238, the windshield 240 and the door 246 have been represented for clarity. These various elements are identical to the corresponding elements described with reference to the preceding figures. The door 246 is however, here, in a configuration opposite to the door 146 of FIG. 6.

In this figure, two modules 210a, 210b, for example identical to the module 10 described above, have been represented installed parallel to one another, in longitudinally offset positions.

FIG. 8, which is a plan view of FIG. 7, represents the module 210a positioned according to the median axis A of the cockpit, opposite the centre of the windshield 240 and as close as possible thereto (as in the position of FIG. 4). The second module 210b is arranged axially set back relative to the first module 210a (the module 210b is further away from the centre of the windshield than the module 210a and it is closer to the bulkhead 238 than the latter). The module 210b is offset laterally relative to the median axis A but remaining arranged opposite a part of the windshield, more specifically, opposite one 240a of the two lateral returns 240a, 240b of the windshield.

This configuration is provided for two pilots (a pilot and a co-pilot).

Such a configuration makes it possible to save space in the cockpit and, therefore, reduce its external dimensions, thus leading to a smaller outside wetted surface for better performance levels.

The installation of the modules is identical to what was described with reference to FIG. 5.

It will be noted that the module 210b can alternatively be arranged on the opposite side of the axis A (symmetry in relation to this axis).

Alternatively, a third module can be arranged in the position situated on the opposite side of the axis A and obtained by a symmetry of the module 210b in relation to this axis.

The module according to the invention incorporating, on the one hand, at least a part of the piloting equipment and controls (e.g.: thrust and reversal controls, rudder bars, etc.) necessary for flying an aircraft and, on the other hand, a single pilot seat comprising or not at least some piloting controls, forms a fully equipped structural assembly and is dedicated to a single pilot. This assembly comprises thrust and reversal controls and the elements of the central and lateral consoles.

This module is independent of the cockpit, which allows it to be assembled (manufactured and equipped) and tested outside of an aircraft. When the assembly and the testing of the module are completed, the latter can be transported in a single operation to the interior of the aircraft to be located therein in its final functional position.

When two modules are located in a cockpit, the rudder bar systems of the two modules are not mechanically coupled. However, some controls can be coupled.

The presence of one or more modules in an aircraft cockpit makes it possible to simplify the configuration and the manufacturing of the cockpit (and therefore of the nose cone). In effect, the interfacing between the module or modules and the cockpit (mechanical, electrical and possibly aeraulic interfaces) is for example limited to just the cockpit floor or to one or more other zones of the cockpit to which the module or modules can be fixed. In a conventional cockpit configuration, the cockpit includes numerous interfaces for the purpose of integration of the cockpit equipment items and of the piloting controls.

The elimination of the conventional configuration with a central console between the two seats (pilot and co-pilot) and the presence of two adjacent modules make it possible to reduce the distance between the two adjacent seats.

This arrangement makes it possible to reduce the width of the nose cone at the level of the cockpit which incorporates such modules. Benefits are derived therefrom in terms of reduction of embedded weight, of wetted surface, of drag, of windshield surface, of zone to be pressurized and of noise.

The module according to the invention also makes it possible to simplify the structure of the cockpit and the integration of the systems in the cockpit, and to simplify the manufacturing of the cockpit and its assembly on the final assembly line.

The integration of one or more modules in the cockpit is particularly simple to perform compared to the integration of the cockpits in the prior art where numerous systems to be connected/interfaced were scattered at several points. All the Interfaces are also situated for example at the level of the floor of the cockpit or else at the level of the zone or zones where the module or modules can be fixed, which limits the personnel intervention zones. Furthermore, the intervention personnel can operate in complete peace on an uncluttered flat floor and not in a tight zone.

It will be noted that one or other of the modules previously described can be located in the cockpit of the nose cone from the rear of the fuselage, before an Internal wall is put in place between the cockpit and the cabin space. In these conditions, the transverse dimension of the module does not therefore need to be adapted to the width of an opening/door for access on board the aircraft and/or to the width of an opening/door for access to the cockpit of the aircraft for its installation in the cockpit. By contrast, it is possible to envisage being able to remove the module from the cockpit subsequently, once the aircraft is completed, even after it has been commissioned. For this, the transverse dimension of the module must therefore be adapted to the width of the access openings/doors through which it must pass to be removed from the aircraft.

As a variant, the different parts S1, S2, S3 and S4 of the structure S described above may be not distinct but jointly form a unit of a single piece. The different box sections can thus be of a single piece with the structure. Moreover, the arrangement, the location of the equipment items and controls could be different. Only the rear part cannot contain equipment items and/or controls.

As a variant, the shape of the structure forming the module can vary. Thus, in a way not represented, the module has a structure which totally surrounds the seat and supports some piloting equipment items and/or controls. The structure completely surrounds the seat means that the structure incorporates a virtual windshield (for example in the space E of FIG. 1) produced from reproductions of images from camera(s) present on board the aircraft and capturing images in particular of the environment outside the aircraft.

As a variant, the number of the box sections that make up the structure can vary. For example, the number and the shape of the box sections C1 to C5 can vary. The box sections C4 and C5 can be combined in one and the same box section bent with its concavity directed towards the seat. It will be noted that the roof shape of the box sections C4 and C5 or the alternative incurved shape enables a pilot to more easily access the seat than if the box section or sections that make up the upper part S3 is/are planar or substantially planar. Other elements that make up the structure can be directly linked to the seat.

Moreover, the central opening E can be equipped with a frame linking the two box sections C3 and C4 to stiffen the assembly or be equipped with a pane.

As a variant, the box section C6 can be eliminated. The seat 12 then forms, by its backrest, the rear of the structure and the upper part S3 is directly attached to the backrest of the seat by its box section C5.

It will be noted that, as a variant, the controls of the armrests can be reversed.

According to another variant not represented, the piloting controls are all present on the structure and none is installed on the seat.

According to yet another variant not represented, the module is suspended from the internal structure of the aircraft instead of being fixed to the floor of the cockpit.

According to yet another variant not represented, the module is fixed to the rear separation bulkhead of the cockpit such as the bulkhead 36 in FIGS. 2 and 4.

It will be noted that, depending on the aircraft configurations, a single door for access on board can be present in the zone adjacent to the rear separation bulkhead of the cockpit, even two doors which may or may not be longitudinally offset relative to one another.

1. An aircraft cockpit module (10) comprising:
a single pilot seat (12) and at least a part of piloting equipment and controls necessary to fly an aircraft;
structural elements which, when assembled with the seat, form said module (10),
said at least a part of the piloting equipment and controls being divided up between the seat and at least some of the structural elements,
wherein the module (10) forms an assembly configured to be moved unitarily and to be integrated in a single operation in an aircraft cockpit.

2. The aircraft cockpit module according to claim 1, wherein the module is designed in such that all of the structural elements assembled mechanically with the seat have a mechanical rigidity enabling said module to be transported in a single block and installed in the aircraft cockpit in a final functional position.

3. The aircraft cockpit module according to claim 1, wherein the structural elements of the module comprise a part forming a support of the seat and to which the seat is fixed.

4. The aircraft cockpit module according to claim 1, wherein the structural elements of the module form a structure which at least partially surrounds the seat (12) and which forms a mechanical framework to which the seat is fixed.

5. The aircraft cockpit module according to claim 4, wherein the structure supports at least some of the piloting equipment and/or controls.

6. The aircraft cockpit module according to claim 4, wherein the structure at least partially surrounds the seat according to a view taken at right angles to a plane containing, on the one hand, a longitudinal axis x corresponding to the axis of alignment from the front to the rear of the seat and, on the other hand, a vertical axis z corresponding to the height of the seat and at right angles to the longitudinal axis.

7. The aircraft cockpit module according to claim 6, wherein the structure has a generally S or G shape according to a view taken at right angles to a plane parallel to the x and z axes.

8. The aircraft cockpit module according to claim 1, wherein the seat (12) comprises at least some piloting controls.

9. The aircraft cockpit module according to claim 1, wherein the module comprises all the piloting equipment and controls necessary for flying an aircraft.

10. The aircraft cockpit module according to claim 1, wherein the module has a width or transverse dimension sized to fit through a width of an opening (38) for access to the aircraft cockpit.

11. The aircraft cockpit module according to claim 1, wherein the module comprises mechanical link elements (50) and electrical connection elements (52) which cooperate mechanically and electrically with the aircraft cockpit.

12. An aircraft comprises the cockpit (32) and the cockpit module (10) as in claim 1, wherein the cockpit module (10) being fixed to an interior of the cockpit.

13. The aircraft according to claim 12, wherein the module is configured to be transported inside the cockpit and to be located and fixed in a final functional position in the cockpit.

14. The aircraft according to claim 12, wherein the module has a width or transverse dimension adapted to pass through a width of an opening (42) for access on board the aircraft and/or to a width of an opening (38) for access to the cockpit of the aircraft.

15. A method for installing an aircraft cockpit module in an aircraft or for removing an aircraft cockpit module from the aircraft, wherein the aircraft comprises an opening (42) for access on board the aircraft and/or an opening (38) for access to an aircraft cockpit, the method comprising a step of passing the aircraft cockpit module through said access opening, wherein the aircraft cockpit module includes a single pilot seat (12), at least some piloting equipment and controls necessary to fly an aircraft structural elements which at least partially surround the single pilot seat, wherein the module (10) forms an assembly configured to be moved unitarily and to be integrated in a single operation in an aircraft cockpit.

16. An aircraft cockpit module comprising:
a structural framework configured to be releasably attached to a cockpit in a fuselage of an aircraft, the framework including a base frame, a front frame, a rear frame and an upper frame arranged in a fixed relationship to each other;
a single pilot seat mounted to and upstanding from the base frame, wherein the single pilot seat is within the framework and rearward of the front frame in a direction parallel to an axis of the fuselage, forward of the rear frame and below the upper frame;
at least one foot pedal mounted to the front frame and positioned forward of the single pilot seat, wherein the at least one foot pedal is configured to connect to a rudder bar system of the aircraft;
an overhead display mounted to the upper frame and positioned to be in a field of view of a pilot seated in the single pilot seat, wherein the overhead display is configured to display information generated by control systems in the aircraft;
wherein the aircraft cockpit module is sized to fit through a door in a bulkhead separating the cockpit from other portions of the fuselage.

17. The aircraft cockpit module of claim 16 wherein a gap between the upper frame and the front frame forms an open region of the module, wherein the open region provides a field of view for a pilot in the single pilot seat to view substantially all portions of a windshield of the aircraft.
